(19) United States
(12) Patent Application Publication
(10) Pub. No.: US 2009/0162511 A1
(43) Pub. Date: Jun. 25, 2009

(54) NATURAL SWEETNER COMPRISING POWDERED LUO HAN GUO WHOLE FRUIT EXTRACTS

(76) Inventors: Yuan SHI, Little Neck, NY (US); Yvonne H. Zhang, Farmingdale, NY (US); Wendy Peng, Las Vegas, NV (US)

Correspondence Address: LAW OFFICES OF ALBERT WAI-KIT CHAN, PLLC, WORLD PLAZA, SUITE 604, 141-07 20TH AVENUE, WHITESTONE, NY, 11357, US

(21) Appl. No.: 11/960,826

(22) Filed: Dec. 20, 2007

(51) Int. Cl. A23L 1/221

(52) U.S. Cl. 426/548

(57) ABSTRACT

The present invention provides a natural sweetener composition comprising powdered extracts of Luo Han Guo whole fruits, mogrosides, and one or more dietary fiber. In one embodiment, extracts obtained from Luo Han Guo whole fruits are first made into powder form. Mogrosides and/or mogroside-V are then added to the powder extract, which is further formulated with dietary fiber such as inulin into a natural sweetener composition.

Throughout this application, various references are referred to and disclosures of these publications in their entireties are hereby incorporated by reference into this application to more fully describe the state of the art to which this invention pertains.

### FIELD OF THE INVENTION

This invention relates to a natural sweetener composition comprising extracts of Luo Han Guo fruit of the Curcubitaceae family.

### BACKGROUND OF THE INVENTION

Luo Han Guo (Siraitia grosvenori or Momordica grosvenori) is the fruit of the plant Siraitia grosvenorii in the Curcubitaceae family. The fruit is well-known for its sweet taste. There are no reported incidents of negative side effects of Luo Han Guo, which is classified by the American Food and Drug Administration as a GRAS (generally recognized as safe) product. There are no restrictions on consuming the Luo Han Guo fruit or its extracts.

The Encyclopedia of Traditional Chinese Medicine (Jiangsu New Medical College, 1977) recommends using dried Luo Han Guo fruits as a remedy for respiratory complaints such as dry coughs, and it can be used as a laxative as well. The book “Fruit as Medicine,” (Dai and Liu, 1986) reported that Luo Han Guo fruits are used as a remedy for heat stroke with thirst, acute and chronic throat inflammation, aphonia, chronic cough, constipation due to aging, and as a sugar substitute for diabetics. Luo Han Guo and its sweetening component are often mentioned in relation to diabetes and obesity because it can be used as a substitute for caloric sugars that are normally consumed in the diet.

The sweet taste of Luo Han Guo comes mainly from the mogrosides, a group of triterpene glycosides, named mogroside-V, mogroside-IV, mogroside-VI, 11-oxo-mogroside-V and siamenoside-I. Mogrosides are non-caloric sweeteners that have a low glycemic index (approximately 20; while the index for sugar is 70). The chemical structures of mogrosides are different from that of sugar, glucose and fructose, and mogrosides are not involved in blood glucose activity. As a sugar substitute, mogrosides' taste has a slower onset and longer duration than that of sugar.

Pure mogroside-V is 300 times sweeter than sugar. There are mogroside sweeteners on the market, which are mainly mogrosides formulated with sugar, xylitol, etc. Although some mogroside sweeteners claim to contain Lou Han Guo concentrate or juice, those mogroside sweeteners do not contain extracts of Luo Han Guo whole fruit.

Sugar is devoid of minerals, vitamins, fiber, and has such a deteriorating effect on the endocrine system that major researchers and health organizations (e.g. American Dietetic Association and American Diabetic Association) agree that sugar consumption in America is one of the major causes of degenerative diseases. Hence, there is a need for an alternate sweetener that does not have the undesirable effects of sugar. In view of the benefits of Luo Han Guo, it is highly desirable to bring all the advantages of Luo Han Guo together and incorporate into a natural, sugar-free sweetener.

### SUMMARY OF THE INVENTION

The present invention provides a natural sweetener composition comprising powdered extracts of Luo Han Quo whole fruits, mogrosides, and one or more dietary fiber. In one embodiment, extracts obtained from Luo Han Guo whole fruits are first made into powder form. Mogrosides and/or mogroside-V are then added to the powder extract, which is further formulated with dietary fiber such as inulin into a natural sweetener composition. The natural sweetener composition of the present invention does not taste like mogrosides. It tastes more like sugar.

### DETAILED DESCRIPTION OF THE INVENTION

The present invention provides a method of preparing powdered whole fruit extracts from the fruits of Luo Han Guo. The method comprises soaking Luo Han Guo fruits in hot water for a few minutes, which will increase the sweetness of the extracts and make the color of the extracts lighter. Breaking the fruit's skin will help the extraction process. After the extracts are filtered and concentrated, the liquid extracts are made into dry extracts as powder. The powders are easy to store, package, and/or transport. Since the powder extract is derived from Luo Han Quo whole fruits, the extract comprises all the fresh whole fruit components that may balance each other in taste and function.

Exogenous mogrosides are added to enhance the sweetness of the composition. In one embodiment, the colored mogrosides are de-colored to remove the bitter taste. De-colored mogrosides are generally produced by separation and purification technology that remove the brown colored substance from the mogrosides to produce white or off-white mogrosides.

In one embodiment, the natural sweetener formulated as disclosed herein comprises powdered whole fruit extracts of Luo Han Guo, exogenously added mogrosides and a dietary fiber such as inulin. Inulin, a naturally occurring oligosaccharide, belongs to a soluble fiber family produced by many types of plants, such as leeks, burdock root, artichokes, asparagus, onions, garlic, banans, wheat, and rye. Inulin is a soluble fiber like other fibers that is indigestible by the body and can help slow digestion. Inulin promotes the growth of healthy gut bacteria and improves digestive functioning. It has been suggested that adding inulin to calcium rich foods may boost calcium absorption.

Dietary fibers are usually divided according to whether they are water-soluble or not. Both types of fiber are present in all plant foods, with varying degrees of each according to a plant's characteristics. Insoluble fiber possesses passive water-attracting properties that help to increase bulk, soften stool and shorten transit time through the intestinal tract. Soluble fiber undergoes metabolic processing via fermentation, yielding end-products with broad and significant health effects. Dietary fiber consists of non-starch polysaccharides such as cellulose and many other plant components such as dextrins, inulin, lignin, waxes, chitins, pectins, beta-glucans and oligosaccharides.

In one embodiment, dietary fiber such as inulin is used as a bulk agent to dilute the sweetness of the composition. When the sweetener composition does not contain inulin, the sweetener would have a very sweet taste, which is useful for sweetening drinks or in the cooking industries. One of ordinary skill in the art would readily recognize that other dietary fibers besides inulin can be used in the present invention.

The present invention provides a natural sweetener composition comprising powdered extract of Luo Han Guo whole fruit. In one embodiment, the powdered extract is obtained by a method comprising the steps of: soaking Luo Han Guo fruit in hot water; breaking the fruit's skin; extracting Luo Han Guo fruit by water at 60° C.-80° C.; filtering and concentrating the extracts; and drying the extracts into powder.

In another embodiment, the natural sweetener composition of the present invention comprises powdered extract of Luo Han Guo whole fruit, one or more dietary fiber (such as inulin), and one or more exogenously added mogrosides. In general, the powdered extract is obtained from Luo Han Guo whole fruit comprising mogrosides, minerals, vitamins, fiber, sugar and proteins.

In one embodiment, the one or more exogenously added mogrosides include 11-oxo-Mogroside-V, Mogroside-VI, Mogroside-V, Mogroside-IV, and Siamenoside-I. The mogrosides may further be de-colored to remove bitter taste. In one embodiment, the ratio by weight of Luo Han Guo Extracts:Mogrodises or Mogroside-V may range from about 0.3 to about 2.

The invention being generally described, will be more readily understood by reference to the following examples which are included merely for purposes of illustration of certain aspects and embodiments of the present invention, and are not intended to limit the invention.

### EXAMPLE 1

### Method of Obtaining Powdered Luo Han Guo Whole Fruit Extract

In one embodiment, powdered Luo Han Guo whole fruit extract can be obtained by a method comprising the steps of:

Soaking fresh Luo Han Guo fruits in hot water for a few minutes;

Press the fruits to break the skin;

Dump the fruits into a vessel, cover the fruits with water, and heat to 60° C.-80° C. for about an hour;

Separate the extract from the solid and liquid mixture;

Filter and concentrate the liquid extracts; and

Heat spray drying the concentrated extracts to powder.

### EXAMPLE 2

### Formulation of Luo Han Guo Sweetener

Mogrosides and/or mogroside-V are added to the powdered extract, which is then further formulated with dietary fiber such as inulin into a natural sweetener composition. One of ordinary skill in the art could readily formulate a sweetener composition containing different proportions of percentages of mogroside and/or dietary fiber. For example, a sweetener composition can be formulated to contain 1:1 (weight:weight) of Luo Han Quo Extracts:Mogrodises or Mogroside-V. In another embodiment, the ratio by weight of Luo Han Guo Extracts:Mogrodises or Mogroside-V may range from about 0.3 to about 2. In yet another embodiment, the sweetener composition can be formulated to contain 0.6:0.6:88 (weight:weight:weight) of Luo Han Quo Extracts:Mogrosides or Mogroside-V: Inulin. Here the concentration of mogroside-V is about 40-45%.

What is claimed is:

1. A natural sweetener composition comprising powdered extract of Luo Han Guo whole fruit.

2. The natural sweetener of claim 1, wherein the powdered extract is obtained from Luo Han Quo whole fruit comprising mogrosides, minerals, vitamins, fiber, sugar and proteins.

3. The natural sweetener of claim 1, wherein the composition further comprises one or more exogenously added mogrosides.

4. The natural sweetener of claim 3, wherein the one or more mogrosides are selected from the group consisting of 11-oxo-Mogroside-V, Mogroside-VI, Mogroside-V, Mogroside-IV, and Siamenoside-I.

5. The natural sweetener of claim 3, wherein the mogrosides are de-colored to remove bitter taste.

6. The natural sweetener of claim 3, wherein the composition further comprises one or more dietary fiber.

7. The natural sweetener of claim 6, wherein the dietary fiber is inulin.

8. The natural sweetener of claim 1, wherein the powdered extract is obtained by a method comprising the steps of:
soaking Luo Han Guo fruit in hot water;
breaking the fruit's skin;
extracting Luo Han Guo fruit by water at 60° C.-80° C.;
filtering and concentrating the extracts; and
drying the extracts into powder.

9. The natural sweetener of claim 3, wherein the ratio by weight of Luo Han Guo Extracts:Mogrodises or Mogroside-V ranges from about 0.3 to about 2.
